(19) United States
(12) Patent Application Publication
(10) Pub. No.: US 2007/0289081 A1
(43) Pub. Date: Dec. 20, 2007

(54) Windscreen Wiper Device

(75) Inventors: Achim Kraus, Buehl (DE); Francois Schabanel, Saint Maur Des Fosses (FR)

Correspondence Address: MICHAEL BEST & FRIEDRICH LLP, 100 EAST WISCONSIN AVENUE, MILWAUKEE, WI, 53202, US

(73) Assignee: Robert Bosch GMBH, Stuttgart (DE)

(21) Appl. No.: 11/547,890

(22) PCT Filed: Mar. 17, 2005
(86) PCT No.: PCT/EP05/51248

§ 371 Date: Jun. 8, 2007

(30) Foreign Application Priority Data
Apr. 6, 2004 (DE) 10 2004 016 918.7

(51) Int. Cl. B60S 1/04; B60S 1/34

(52) U.S. Cl. 15/250.34

(57) ABSTRACT

The invention relates to a windshield wiper device, in particular for a motor vehicle, with at least one fastening part (10) for fastening a wiper arm on a wiper shaft (11). The windshield wiper device is located in an area where pedestrians often collide in an impact with a vehicle. As a result, the components of the windshield wiper device frequently represent a great risk of injury for pedestrians. The object of the invention is improving the windshield wiper device to the effect that the risk of injury to the pedestrian is reduced in an impact with the vehicle. According to the invention, the fastening part (10) is provided with a predetermined breaking point (12) and can therefore detach from the wiper shaft (11) in the case of an impact on at least one fastening part (10).

The invention relates to a windshield wiper device, in particular for a motor vehicle, with at least one fastening part for fastening a wiper arm on a wiper shaft.

Pedestrians are completely unprotected in collisions with vehicles. The inflexible hard parts beneath the engine hood especially often produce severe injuries when a pedestrian impacts a vehicle. The windshield wiper device is located in an area that pedestrians frequently impact during a collision. The disadvantage of windshield wiper devices generally known from the prior art is that they represent a great risk of injury for pedestrians in an impact with the vehicle. For this reason, vehicle manufacturers require a minimum clearance of 65 to 85 millimeters between the engine hood and a wiper drive. For this purpose, the distance of the wiper shaft from the lower edge of a windshield is increased. During wiper operation, however, the fastening part is located outside the parking position 10 millimeters above the windshield. When a pedestrian collides with the windshield, it cannot therefore yield more than 10 millimeters because then the fastening part [would] sit on the windshield. However, this deformation path is too short to reduce the risk of injury to the pedestrian.

The object of the invention is to improve a windshield wiper device of the type cited at the outset to the effect that in the future the risk of injury for a pedestrian is reduced in an impact with the vehicle.

The invention attains the stated objective through a windshield wiper device of the type described at the outset in which, according to the invention, at least one fastening part is provided with a predetermined breaking point and can therefore at least partially detach from the wiper shaft in the case of an impact on at least one fastening part. Since during an impact the fastening part is at least partially detachable, the wiper arm connected to the fastening part can yield in the direction of the impact force and thereby reduce the risk of injury for the impacting pedestrian.

Depending upon the angle at which the pedestrian impacts on the fastening part, after the breaking of the predetermining breaking point, the fastening part can either be shifted over the wiper shaft or yield transverse to the wiper shaft.

In a structurally simple embodiment, the fastening part can have a hollow cylinder, which is mounted on the wiper shaft.

The hollow cylinder can have a circumferential predetermined breaking point on a front side facing the wiper shaft. In the case of an impact with a pedestrian, at least a portion of the front side is broken out of the hollow cylinder.

So that the hollow cylinder fails in a reliable manner at the predetermined breaking point, it can be a circumferential groove.

To guarantee that it breaks at the predetermined breaking point at even low impact forces, the groove can taper towards its groove base.

So that a torque can be transmitted from the wiper shaft to the wiper arm via the fastening part, the fastening part can have a conical bore hole into which a conical end of the wiper shaft can be inserted. A screwed connection can be provided so that the conical bore hole is pressed firmly against the conical end of the wiper shaft.

In addition, the invention relates to a windshield wiper device of the type cited at the outset in which, according to the invention, at least one fastening part has a tubular element mounted on the wiper shaft and a connecting element, wherein the connecting element is connected on one end to the wiper arm and is connected on the other end in a detachable manner to the tubular element. When a pedestrian impacts the windshield wiper device, the connecting element and the tubular element can detach from each other so that the tubular element together with the rest of windshield wiper device can yield to the impact force, thereby clearly reducing the risk of injury to the pedestrian.

The tubular element and the connecting element can be secured to each other. Upon impact the securing detaches so that the tubular element and the rest of windshield wiper device can yield to the impact force. In addition, the securing guarantees a reliable transmission of torque from the tubular element to the connecting element.

In a development of the invention, the tubular element can be mounted diagonally on the wiper shaft. As a result, a wiper blade rubber can be pressed better against a windshield during wiper operation, thereby optimizing the wiping quality at a high wiper speed and/or at a high vehicle speed.

The tubular element can preferably be a cost-effective diecast part and/or the connecting element can be fabricated economically from sheet metal. Consequently, the fastening part can be fabricated in large unit numbers at a low price per unit.

Particularly in the case of opposed wiper systems where, when in operation, the wiper arms move in opposite directions of one another, the fastening part that is provided with a tubular element mounted diagonally on the wiper shaft can be fabricated economically. Until now two separate tools were required in the case of opposed wiper systems for the left and right fastening parts. However, if the fastening part features the tubular part and the connecting element, the left and the right fastening parts can be manufactured with only one tool. For this purpose, the tubular element must be inserted into the securing tool rotated respectively by only 180 degrees.

Various exemplary embodiments are explained in greater detail in the following on the basis of the enclosed drawings.

They show the following in detail:

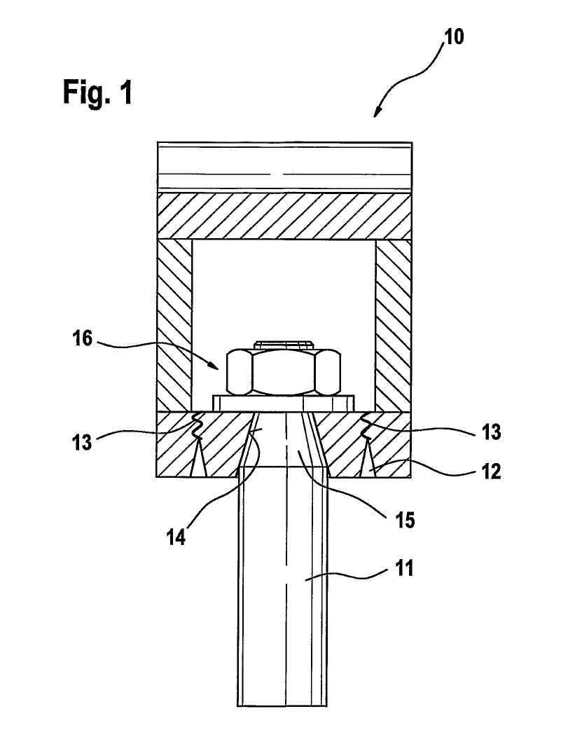

FIG. 1 A longitudinal section through a first embodiment of the fastening part;

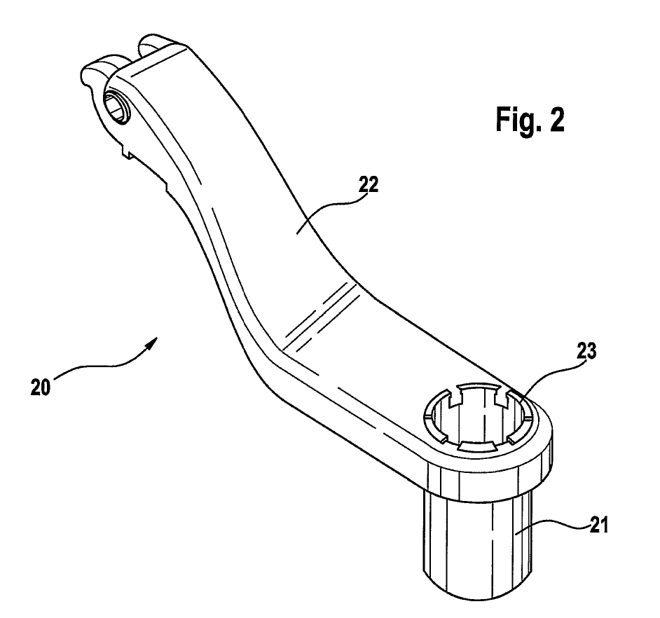

FIG. 2 A perspective view of a second embodiment of the fastening part;

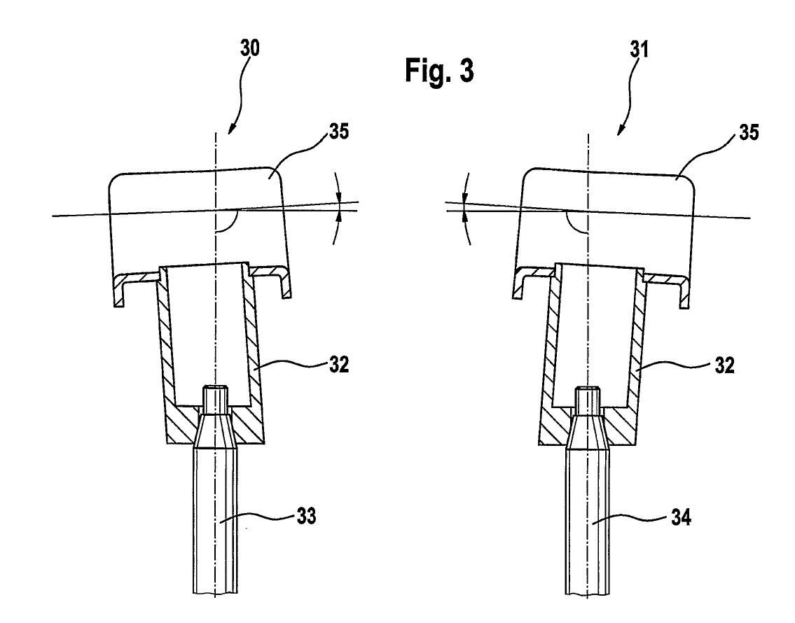

FIG. 3 A sectional view through two fastening parts of an opposed wiper system.

FIG. 1 shows a fastening part 10 of a windshield wiper device that is not shown here in greater detail. The fastening part 10 connects a wiper arm (not shown here in greater detail) to a wiper shaft 11. It is embodied as a hollow cylinder. The fastening part 10 has a predetermined breaking point 12 embodied as a circumferential groove on a side facing the wiper shaft 11. In an impact with a pedestrian the fastening part 10 will fail at the predetermined breaking point 12. So that a break of the fastening part 10 is already initiated with low impact forces, the groove 12 tapers towards its groove base. Serpentine lines 13 represent a possible break. The fastening part 10 is at least partially detached from the wiper shaft 11 due to the break. Depending upon the angle at which the pedestrian impacts the fastening part 10, the fastening part 10 is shifted either over the wiper shaft 11 or it yields transverse to the wiper shaft 11 so that it is bent away laterally, for example.

The fastening part 10 is provided with a conical bore hole 14 in order to be able to transmit a torque from the wiper shaft 11 to the wiper arm via the fastening part 10. A conical end 15 of the wiper shaft 11 is inserted into the conical bore hole 14. The conical end 15 is pressed firmly into the conical bore hole 14 with a screwed connection 16, thereby assuring a reliable transmission of torque.

FIG. 2 shows a fastening part 20, which has a tubular element 21 and a connecting element 22. The tubular element 21 can be mounted on a wiper shaft that is not shown here in greater detail. A wiper arm that is also not shown here can be mounted on the connecting element 22. The tubular element 21 and the connecting element 22 are connected to one another in a detachable manner via a securing 23. Upon impact of a pedestrian with the windshield wiper device, the tubular element 21 and the connecting element 22 can detach from one another. In this way, the tubular element 21 together with the rest of windshield wiper device can yield to the impact force thereby reducing the risk of injury to the pedestrian. In addition, the securing 23 guarantees a reliable transmission of torque from the tubular element 21 to the connecting element 22. All securing methods known to the person skilled in the art can be used for the securing between the tubular element 21 and the connecting element 22. The tubular element 21 can preferably be a cost-effective diecast part and/or the connecting element 22 can be an economical sheet metal part. The tubular element 21 advantageously has a conical bore hole for receiving the conical end of the wiper shaft.

FIG. 3 shows two fastening parts 30 and 31 of an opposed wiper system where, when in operation, the wiper arms move in opposite directions of one another. In the case of the fastening parts 30 and 31, tubular elements 32 are mounted diagonally on the wiper shafts 33 and 34. As a result, a wiper blade rubber is pressed against the windshield better during wiper operation so that the wiping quality is optimized at high wiper speeds and/or high vehicle speeds. Because of the simple design of the tubular elements 32 and the connecting elements 35, the fastening parts 30 and 31 can be manufactured economically, particularly for opposed wiper systems. Until now, two separate tools were required for the left and the right fastening parts in the case of opposed wiper systems. If, however, the fastening parts 30 and 31 are supposed to be used for an opposed wiper system, both the left and the right fastening parts can be manufactured with only one tool. For this purpose, the tubular element must be inserted into the securing tool during manufacturing rotated respectively by only 180 degrees.

1. Windshield wiper device, for a motor vehicle, with at least one fastening part (10) for fastening a wiper arm on a wiper shaft (11), characterized in that the fastening part (10) is provided with a predetermined breaking point (12) and can therefore detach from the wiper shaft (11) in the case of an impact on the fastening part (10).

2. Windshield wiper device according to claim 1, characterized in that, after the breaking of the predetermining breaking point (12), the fastening part (10) can be shifted over the wiper shaft (11).

3. Windshield wiper device according to claim 1, characterized in that the fastening part (10) has a hollow cylinder, which is mounted on the wiper shaft (11).

4. Windshield wiper device according to claim 3, characterized in that the hollow cylinder has a circumferential predetermined breaking point (12) on a front side facing the wiper shaft (11).

5. Windshield wiper device according to claim 4, characterized in that the circumferential predetermined breaking point (12) is a circumferential groove.

6. Windshield wiper device, for a motor vehicle, with at least one fastening part (20, 30, 31) for fastening a wiper arm on a wiper shaft (33, 34), characterized in that the fastening part (20, 30, 31) has a tubular element (21, 32) mounted on the wiper shaft (33, 34) and a connecting element (22, 35), wherein the connecting element (22, 35) is connected on one end to the wiper arm and is connected on the other end in a detachable manner to the tubular element (21, 32).

7. Windshield wiper device according to claim 6, characterized in that the tubular element (21, 32) and the connecting element (22, 35) are secured to one another.

8. Windshield wiper device according to claim 6, characterized in that the tubular element (32) is mounted diagonally on the wiper shaft (33, 34).

9. Windshield wiper device according to claim 6, characterized in that the tubular element (21, 32) is a diecast part.

10. Windshield wiper device according to claim 6, characterized in that the connecting element (22, 35) is fabricated of sheet metal.

11. Windshield wiper device according to claim 7, characterized in that the tubular element (32) is mounted diagonally on the wiper shaft (33, 34).

12. Windshield wiper device according to claim 7, characterized in that the tubular element (21, 32) is a diecast part.

13. Windshield wiper device according to claim 7, characterized in that the connecting element (22, 35) is fabricated of sheet metal.

14. Windshield wiper device according to claim 11, characterized in that the tubular element (21, 32) is a diecast part.

15. Windshield wiper device according to claim 11, characterized in that the connecting element (22, 35) is fabricated of sheet metal.

16. Windshield wiper device according to claim 14, characterized in that the connecting element (22, 35) is fabricated of sheet metal.
